(19) United States
(12) Patent Application Publication
(10) Pub. No.: US 2011/0058391 A1
(43) Pub. Date: Mar. 10, 2011

(54) INVERTER DEVICE

(75) Inventor: Hiroshi UENO, Aichi (JP)

(73) Assignee: KABUSHIKI KAISHA TOKAI RIKA DENKI SEISAKUSHO, Aichi (JP)

(21) Appl. No.: 12/872,576

(22) Filed: Aug. 31, 2010

(30) Foreign Application Priority Data
Sep. 8, 2009 (JP) 2009-206955

(51) Int. Cl. H02M 7/00

(52) U.S. Cl. 363/13

(57) ABSTRACT

An inverter device includes a power module, which converts DC power into AC power, and a bus bar, which is fastened to a terminal of the power module by a bolt. In a state in which a current sensor is arranged between the terminal of the power module and the bus bar, the bolt fastens together the bus bar, the current sensor, and the terminal. The current sensor detects current flowing through the bolt to detect current flowing through a power supply route, which includes the bus bar.

### CROSS-REFERENCE TO RELATED APPLICATIONS

This application is based upon and claims the benefit of priority from prior Japanese Patent Application No. 2009-206955, filed on Sep. 8, 2009, the entire contents of which are incorporated herein by reference.

### BACKGROUND OF THE INVENTION

The present invention relates to an inverter device that converts DC power into AC power and supplies the converted AC power to a current supplying subject.

In a so-called hybrid vehicle, an internal combustion engine and a motor are both used as a power source to reduce exhaust gas and improve fuel efficiency. A typical hybrid vehicle includes an inverter device that converts DC power, which is supplied from a vehicle battery, into three-phase AC power. The three-phase AC power converted by the inverter device is supplied to the motor, which serves as a power supplying subject. In the hybrid vehicle, a power supply conductor, for example, a bus bar or cable, connects the motor to a power module such as an insulated gate bipolar transistor (IGBT) arranged in the inverter device. A current sensor is coupled to the power supply conductor. The current sensor detects the current flowing through the bus bar or cable and controls the power supplied to the motor based on the detected current. Japanese Laid-Open Patent Publication No. 2006-194650 describes a prior art example of an inverter device.

In the device described in Japanese Laid-Open Patent Publication No. 2006-194650, a bus bar has a basal portion connected to a power module by a bolt. Further, the bus bar has a distal portion mold-sealed by a resin member together with electronic components such as a magnetic core and a Hall element. The mold-sealed portion forms a current sensor. In this prior art device, the resin member forming the current sensor is used as an output terminal block for the inverter device. As a result, the inverter device has fewer components, a simpler structure, and a smaller size.

### SUMMARY OF THE INVENTION

In the prior art device, the bus bar connects the power module and current sensor. Thus, the power module and current sensor are spaced apart from each other by a distance corresponding to the length of the bus bar. The distance between the power module and the current sensor enlarges the inverter device.

It is an object of the present invention provides a compact inverter device that includes a current sensor.

One aspect of the present invention is an inverter device including a power module, a bus bar, and a current sensor. The power module converts DC power into AC power. The bus bar forms a power supply route for a current supplying subject and is fastened to the power module by a bolt. The power supply path including the bus bar supplies the current supplying subject with the AC power converted by the power module. The current sensor has an insertion hole for insertion of a detected body including the bolt. The current sensor is arranged between the power module and the bus bar by the bolt inserted into the insertion hole. The current sensor detects current flowing through the bolt to detect current flowing through the power supply route.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an exploded perspective view showing an inverter device according to a first embodiment of the present invention;

FIG. 2 is an exploded perspective view showing a bus bar connected to the U phase of a motor and the U phase terminal of a power module in the inverter device of FIG. 1;

FIG. 3 is a cross-sectional view showing the connected portion of FIG. 2 after coupling;

FIG. 4 is an exploded perspective view showing a connected portion of a bus bar connected to a U phase of a motor and a U phase terminal of a power module in an inverter device according to a second embodiment of the present invention; and

FIG. 5 is a cross-sectional view showing the connected portion of FIG. 4 after coupling.

### DETAILED DESCRIPTION OF THE PREFERRED EMBODIMENTS

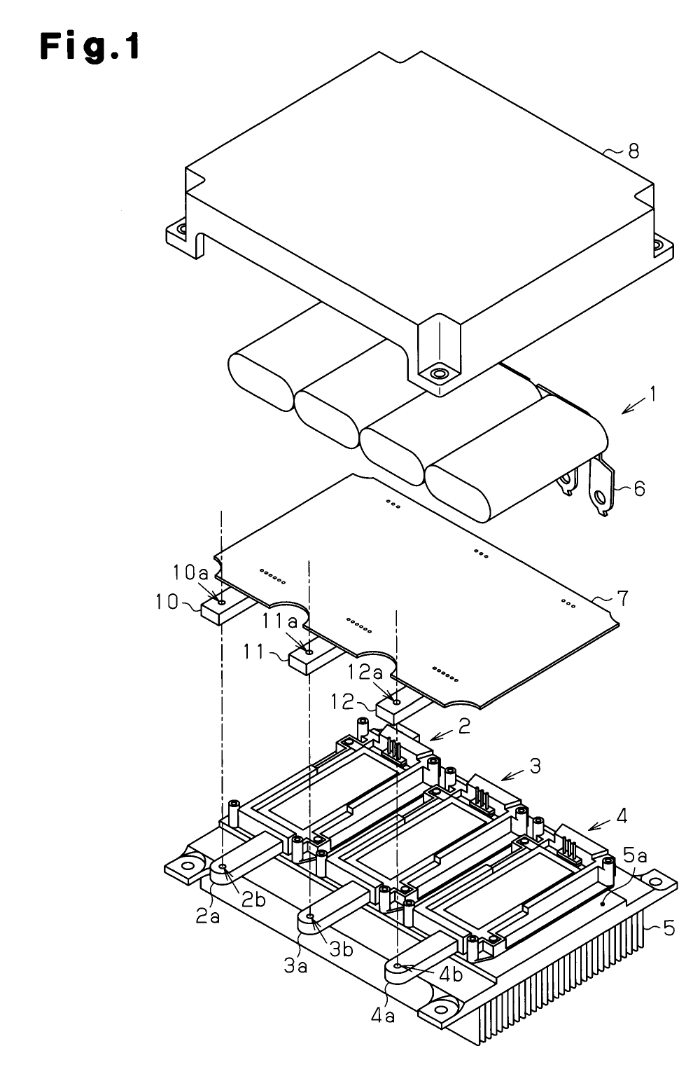

A first embodiment of the present invention will now be discussed with reference to FIGS. 1 to 3. The structure of an inverter device will first be briefly described with reference to FIG. 1. In a non-restrictive example, an inverter device according to the present invention is suitable for use in a hybrid vehicle. The inverter device converts DC power supplied from a vehicle battery into three-phase AC power. Further, the inverter device supplies the converted three-phase AC power to a motor, which serves as a power source for the hybrid vehicle.

As shown in FIG. 1, the inverter device includes a smoothing capacitor 1, three power modules 2 to 4, and a heat sink 5. The smoothing capacitor 1 smoothes the DC power supplied from the vehicle battery. The three power modules 2 to 4 convert the smoothed DC power from the smoothing capacitor 1 into three-phase power. The heat sink 5 increases heat dissipation from the power modules 2 to 4. An upper case 8 is coupled to an upper part of the heat sink 5 by bolts (not shown). The upper case 8 protects electronic components, such as the smoothing capacitor 1 and the power modules 2 to 4, from the ambient environment.

A bus bar 6 is arranged on the smoothing capacitor 1 and connected to input terminals (not shown) of the power modules 2 to 4. The DC power smoothed by the smoothing capacitor 1 is supplied via the bus bar 6 to the power modules 2 to 4.

The power modules 2 to 4 each include semiconductor elements such as an IGBT, which is described above. The power modules 2 to 4 are each connected to a control substrate 7, which is arranged between the power modules 2 to 4 and the smoothing capacitor 1. The power modules 2 to 4 respectively include a U phase terminal 2a, a V phase terminal 3a, and a W phase terminal 4a, which output power for the three phases (U phase, V phase, and W phase) of the three-phase AC power and which are formed from a conductive material. In the illustrated example, the terminals 2a, 3a, and 4a are plate-shaped members and extend from the corresponding power modules 2, 3, 4 in the same direction. The terminals 2a, 3a, and 4a include distal portions having threaded holes 2b, 3b, and 4b, respectively. The power modules 2 to 4 convert the smoothed DC power from the smoothing capacitor 1 into three-phase AC power and output the converted three-phase AC power from the terminals 2a, 3a, and 4a.

Three sensors 10 to 12 respectively facing toward the terminals 2a, 3a, and 4a are mounted on the control substrate 7. The current sensors 10 to 12 have distal portions extending in the same direction from the control substrate 7. In the illustrated example, the current sensors 10, 11, and 12 extend in the same direction as the corresponding terminals 2a, 3a, and 4a of the power modules 2, 3, and 4 so that the current sensors 10, 11, and 12 face toward and contact the terminals 2a, 3a, and 4a. The current sensors 10 to 12 include distal portions having insertion holes 10a, 11a, and 12a that are coaxial with the threaded holes 2b, 3b, and 4b, respectively. A detected body is inserted into each of the insertion holes 10a, 11a, and 12a. When current flows through the detected body inserted into each of the insertion holes 10a, 11a, and 12a, the corresponding one of the current sensors 10 to 12 detect the magnetic flux generated near the detected body to detect the current flowing through the detected body from the detected magnetic flux. In the illustrated example, the detected body includes a bolt 13.

In the prior art inverter device described above, the power module is spaced apart from the current sensor. Thus, the substrate, on which the power module is mounted, is connected to the current sensor by a connection member such as a harness. In such a structure, when a signal output from the current sensor to the substrate passes through the harness, for example, electromagnetic noise or the like may affect and lower the current detection accuracy. In this aspect, the present embodiment mounts the current sensors 10 to 12 on the control substrate 7. Thus, signals do not have to be relayed by a harness or the like between the current sensors 10 to 12 and the control substrate 7. Further, the current sensors 10 to 12 may be connected to the control substrate 7 by wiring of a minimal length. As a result, the signals output from the current sensors 10 to 12 to the control substrate 7 are subtly affected by electromagnetic noise or the like. This increases the current detection accuracy.

The inverter device of the present embodiment supplies the three-phase AC power converted by the power modules 2, 3, and 4 to the above-described motor from the terminals 2a, 3a, and 4a via the bus bar 9.

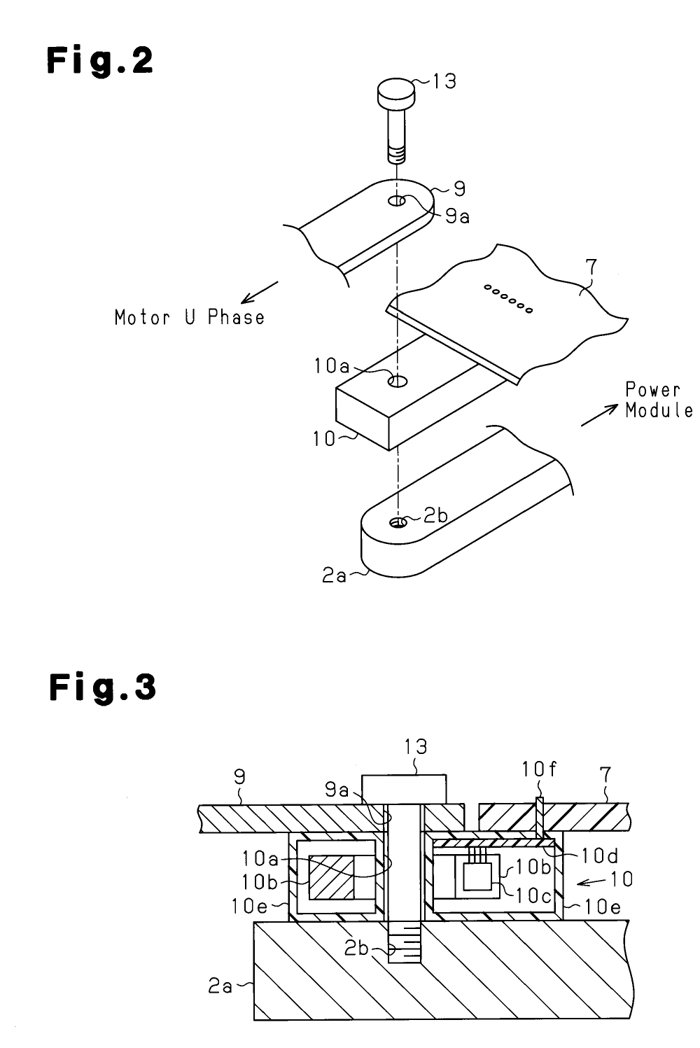

The structure of the portion connecting the U phase bus bar 9, which is connected to the U phase of the motor, and the U phase terminal 2a will now be described with reference to FIGS. 2 and 3.

As shown in FIGS. 2 and 3, the U phase bus bar 9, which is conductive and planar, is arranged on the current sensor 10. Further, the U phase bus bar 9 includes a distal portion having an insertion hole 9a through which the bolt 13 is inserted. In a non-restrictive example, the bolt 13 is formed from a conductive and non-magnetic material such as stainless steel. The bolt 13 is inserted into the insertion hole 9a of the U phase bus bar 9 and mated with the threaded hole 2b. This fastens the U phase bus bar 9 to the U phase terminal 2a with the current sensor 10 arranged in between. Accordingly, the U phase power output from the U phase terminal 2a is supplied to the U phase of the motor using the bolt 13 and the U phase bus bar 9 as a power supply route. The V phase and W phase bus bars (not shown) respectively connected to the V phase and W phase of the motor have the same structure as the U phase bus bar 9 and are connected to the terminals 3a and 4a of the power modules 3 and 4.

As shown in FIG. 3, the current sensor 10 includes a magnetic core 10b, a substrate 10d, and a case 10e. The magnetic core 10b serves as a magnetic circuit that gathers the magnetic flux generated from the current flowing through the bolt 13. Various types of electronic components, which include a Hall element 10c, are mounted on the substrate 10d. The case 10e is formed from resin and box-shaped to accommodate the magnetic core 10b, the electronic components, and the substrate 10d. The magnetic core 10b is annular and surrounds the insertion hole 10a. A gap is formed in part of the magnetic core 10b to receive the Hall element 10c. In the current sensor 10, when the magnetic core 10b gathers and amplifies the magnetic flux generated by the current flowing through the bolt 13, leakage flux is generated in the gap. The leakage flux acts on the Hall element 10c. More specifically, in the current sensor 10, Hall voltage is generated in correspondence with the leakage flux acting on the Hall element 10c, and the current flowing through the bolt 13 is determined from the Hall voltage. The current sensors 11 and 12 have the same structures and detect current in the same manner as the current sensor 10.

In the inverter device of the present embodiment, the power modules 2 to 4 are located in the proximity of the current sensors 10 to 12. The proximal location is advantageous for reducing the size of the inverter device. The current sensor detects the current flowing through the bolt and allows for the detection of current flowing through the power supply route for each phase of the motor. This obtains a compact inverter capable of accurately detecting the current flowing through the power supply route for each phase of the motor.

The inverter device of the present embodiment has the advantages described below.

(1) The current sensors 10 to 12 are arranged between the terminals 2a, 3a, and 4a of the power modules 2 to 4 and the bus bar connected to each phase of the motor. In this state, the bolts 13 are inserted into the insertion holes 10a, 11a, and 12a of the current sensors 10 to 12. The current sensors 10 to 12 detect the current flowing through the bolts 13 in order to detect the current flowing through a current route for each phase of the motor. In this structure, the power modules 2 to 4 are arranged in the proximity of the current sensors 10 to 12. This allows for reduction in the size of the inverter device while accurately detecting the current flowing through the power supply route for each phase of the motor.

(2) The current sensors 10 to 12 are mounted on the control substrate 7. As a result, the signals output from the current sensors 10 to 12 to the control substrate 7 are subtly affected by electromagnetic noise or the like. This increases the current detection accuracy.

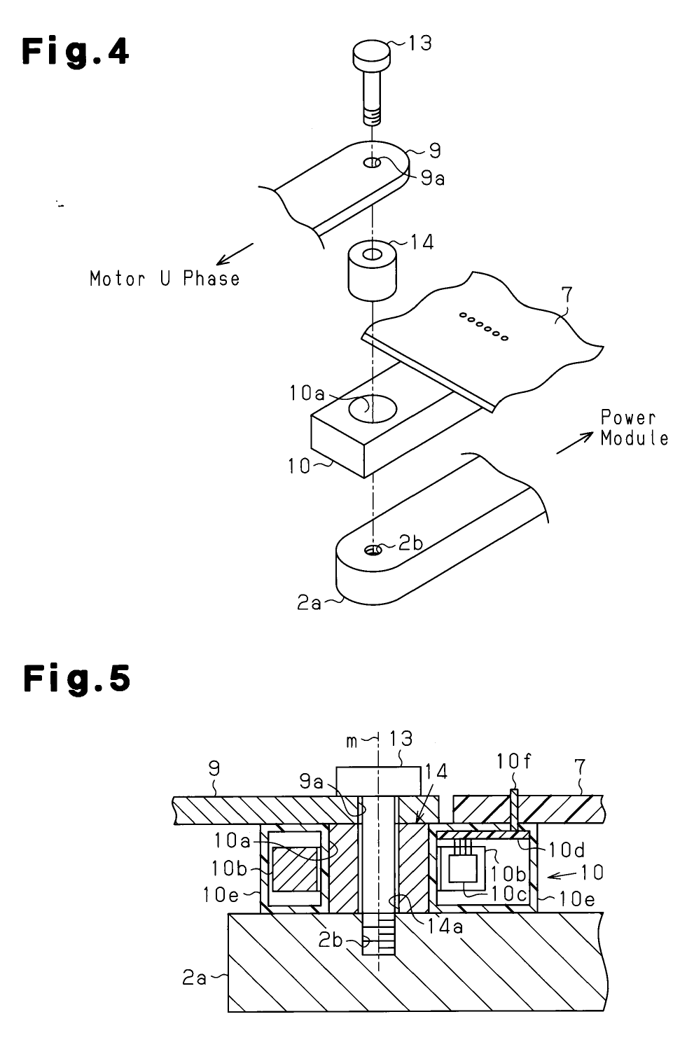

An inverter device according to a second embodiment of the present invention will now be discussed with reference to FIGS. 4 and 5. The structure of the inverter device according to the second embodiment is basically the same as the structure shown in FIGS. 1 to 3. FIG. 4 is an exploded perspective view corresponding to FIG. 2, and FIG. 5 is a cross-sectional view corresponding to FIG. 3. FIGS. 4 and 5 show a portion of the connection between the U phase bus bar 9, which is connected to the U phase of the motor, and the U phase terminal 2a. In FIGS. 4 and 5, like or same reference numerals are given to those components that are the same as the corresponding components shown in FIGS. 2 and 3. Such components will not be described. Only the differences between the two structures will be described below.

As described above, when the current sensor 10 is arranged between the U phase terminal 2a and the U phase bus bar 9, the bolt 13 electrically connects the U phase terminal 2a and the U phase bus bar 9. However, in this case, when supplying a large current to the motor, the bolt 13 may be locally heated depending on the size and material of the bolt 13. To resolve such a problem, in the second embodiment, a conduction member 14 is arranged in the insertion hole 10a of the current sensor 10. The conduction member 14 electrically connects the power module and the bus bar. This decreases the current flowing through the bolt 13 and suppresses the heating of the bolt 13.

In the example of FIG. 4, the insertion hole 10a of the current sensor 10 has an enlarged diameter. The conduction member 14, which has the form of a cylindrical tube, is arranged in the insertion hole 10a to electrically connect the U phase terminal 2a and the U phase bus bar 9. As shown in FIG. 5, the length of the conduction member 14 is the same as the length of the insertion hole 10a in the axial direction (i.e., the direction of axis m). Further, the conduction member 14 has an outer diameter that is about the same as the diameter of the insertion hole 10a and includes an insertion hole 14a for insertion of the bolt 13. The conduction member 14 is formed from a conductive material such as copper. The upper and lower end faces of the conduction member 14 are respectively in contact with the U phase bus bar 9 and the U phase terminal 2a. Thus, the conduction member 14 electrically connects the U phase bus bar 9 and the U phase terminal 2a. As a result, some of the current flowing from the U phase terminal 2a to the U phase bus bar 9 flows through the conduction member 14. This decreases the amount of current flowing through the bolt 13 and consequently suppresses heating of the bolt 13. The current sensor 10 detects, as a Hall voltage, a combined magnetic flux of the magnetic flux generated by the current flowing through the bolt 13 and the magnetic flux generated by the current flowing through the conduction member 14 to detect the current flowing through the power supply route for the U phase of the motor. In the illustrated example, the detected body includes the bolt 13 and the conduction member 14.

The same connecting portion structure is applied for the portion connecting the V phase bus bar and V phase terminal 3a and the portion connecting the W phase bus bar and the W phase terminal 4a.

In addition to the advantages of the first embodiment, the present embodiment has the advantages described below.

(3) The conduction members 14 are arranged in the insertion holes 10a, 11a, and 12a of the current sensors 10 to 12 in order to electrically connect the bus bars, each of which is connected to one of the motor phases, to the corresponding terminals 2a, 3a, and 4a of the power modules 2 to 4. Thus, even when a large current is supplied to the motor, the amount of current flowing to the bolts decreases. This suppresses heating of the bolts.

(4) Preferably, the length of the conduction member 14 is the same as the axial length of the insertion hole 10a, and the outer diameter of the conduction member 14 is about the same as the diameter of the insertion hole 10a. The bolt 13 is inserted through the center hole of the conduction member 14, and the conduction member 14 is held between the power module 2 (3 or 4) and the U phase bus bar 9. In this structure, just by inserting the conduction member 14 into the insertion hole 10a, the conduction member 14 electrically connects the terminal 2a of the power module 2 and the bus bar 9.

(5) Preferably, the inverter device is suitable for supplying AC power to a motor that is used as a power source for a hybrid vehicle. In a hybrid vehicle that uses both an internal combustion engine and a motor as a drive source, the power supplied to the motor from an inverter device is often controlled in accordance with the current detected by the current sensor. Thus, the inverter device of the present embodiment is highly effective when used for a motor (a current supplying subject) of a hybrid vehicle.

It should be apparent to those skilled in the art that the present invention may be embodied in many other specific forms without departing from the scope of the invention. Particularly, it should be understood that the present invention may be embodied in the following forms.

In the second embodiment, the conduction member 14 has the form of a cylindrical tube. However, when the insertion holes 10a, 11a, and 12a have, for example, tetragonal cross-sections, the conduction member 14 may have the form of a tetragonal tube. In this manner, the form of the conduction member 14 may be changed as required. It is only required that the conduction members 14 be inserted in the insertion holes 10a, 11a, and 12a so as to electrically connect the terminals 2a, 3a, and 4a of the power modules 2 to 4 to the bus bars connected to the motor phases.

In each of the above-described embodiments, the current sensors 10 to 12 are mounted on the control substrate 7. However, in an inverter device having a structure in which the terminals 2a, 3a, and 4a are spaced apart from the control substrate 7, when the current sensors 10 to 12 are arranged in the proximity of the terminals 2a, 3a, and 4a, it may be difficult to mount the current sensors 10 to 12 on the control substrate 7. In such a case, the control substrate 7 may be connected to the current sensors 10 to 12 by a connecting member such as a harness. Such a structure would also allow for the inverter device to be reduced in size.

In each of the above-described embodiments, the power modules are formed by semiconductor elements such as an IGBT. However, other semiconductor elements, for example, a power metal-oxide-semiconductor field-effect transistor (MOSFET), may be used to form the power module.

In each of the above embodiments, the present invention is embodied in an inverter device that supplies three-phase AC power to the motor of a hybrid vehicle. Instead, the present invention may be embodied in an inverter device that supplies three-phase AC power to a motor serving as a power source for an electric vehicle.

The present examples and embodiments are to be considered as illustrative and not restrictive, and the invention is not to be limited to the details given herein, but may be modified within the scope and equivalence of the appended claims.

What is claimed is:

1. An inverter device comprising:
a power module that converts DC power into AC power;
a bus bar that forms a power supply route for a current supplying subject, in which the bus bar is fastened to the power module by a bolt, and the power supply path including the bus bar supplies the current supplying subject with the AC power converted by the power module; and
a current sensor including an insertion hole for insertion of a detected body including the bolt, wherein the current sensor is arranged between the power module and the bus bar by the bolt inserted into the insertion hole, and the current sensor detects current flowing through the bolt to detect current flowing through the power supply route.

2. The inverter device according to claim 1, wherein the power module and the current sensor are mounted on the same substrate.

3. The inverter device according to claim 1, wherein the detected body is arranged in the insertion hole and includes a conduction member electrically connecting the power module and the bus bar.

4. The inverter device according to claim 3, wherein the bolt is inserted through the conduction member and holds the conduction member between the power module and the bus bar.

5. The inverter device according to claim 1, wherein the power module includes a terminal extending in one direction, and the current sensor extends in the same direction as the terminal of the power module and faces toward and contacts the terminal.
